(19) United States
(12) Patent Application Publication
(10) Pub. No.: US 2002/0112055 A1
(43) Pub. Date: Aug. 15, 2002

(54) Integrated communication server and method

(76) Inventors: Karen Capers, Castle Rock, CO (US); Michael A. Brooking, Colorado Springs, CO (US)

Correspondence Address: Elsa Keller, Siemens Corporation, 186 Wood Avenue South, Iselin, NJ, 08830, US

(21) Appl. No.: 09/781,925

(22) Filed: Feb. 12, 2001

(51) Int. Cl. G06F 15/173

(52) U.S. Cl. 709/225

(57) ABSTRACT

A method for providing an integrated communication server is provided that includes receiving a selection of at least one service option. Capacity information for at least one type of subscriber is received. A specified set of rules is applied to produce a result set based on the service option selection and the capacity information. Configuration parameters are determined for one or more network elements based on the result set.

### TECHNICAL FIELD OF THE INVENTION

This invention relates generally to the field of communication systems and more particularly to an integrated communication server and method.

### BACKGROUND OF THE INVENTION

Conventional private branch exchanges (PBXs) allow corporations, organizations and other enterprises to provide internal communication services to their personnel. This allows personnel to call each other without using an external public telephone network. Recently, wireless networks and computer networks have been integrated into PBX networks to generate private office networks that are capable of providing wireless communication to users of wireless devices within the private office network.

Disadvantages associated with conventional private office networks include limitations regarding services which may be provided to subscribers through servers in the network. For example, a hard-coded limit typically exists with regard to the number of servers which may be included in the network to provide services for subscribers. Similarly, a hard-coded limit typically exists with regard to which types of servers may be included in the network. In addition, when provisioning the servers for a network, an operator generally needs to know which servers to include in the network and where to locate the appropriate versions of the servers. Thus, conventional private office networks are relatively inflexible, are not scalable, and require the operator to have a relatively large amount of knowledge about the servers during provisioning.

### SUMMARY OF THE INVENTION

In accordance with the present invention, an integrated communication server and method are provided that substantially eliminate or reduce disadvantages and problems associated with conventional systems. In particular, the integrated communication server provides a private office network that is flexible and scalable in that any number of any suitable types of servers may be included with reduced knowledge about the servers required of an operator during provisioning.

According to one embodiment of the present invention, a method for providing an integrated communication server is provided that includes receiving a selection of at least one service option. Capacity information for at least one type of subscriber is received. A specified set of rules is applied to produce a result set based on the service option selection and the capacity information. Configuration parameters for one or more network elements are determined based on the result set.

According to another embodiment of the present invention, a service engine for providing an integrated communication server (ICS) is provided. The service engine includes a rule engine that is operable to receive service and capacity information. The rule engine is also operable to determine which of a plurality of network elements to include in the ICS based on the service and capacity information. The rule engine is also operable to determine configuration parameters for one or more network elements based on the result set.

Technical advantages of one or more embodiments of the present invention include providing an integrated communication server. In a particular embodiment, the integrated communication server determines which servers are needed for a particular private office network based on service and capacity information and other relevant information provided by an operator during provisioning. The integrated communication server also has information regarding where to locate the appropriate versions of the servers. As a result, the operator is not required to know which servers are needed and where the servers are located. Accordingly, the integrated communication server provides a private office network that is relatively simple to implement.

Other technical advantages of one or more embodiments of the present invention include providing a scalable integrated communication server. In a particular embodiment, the integrated communication server may comprise any suitable number of servers. In addition, the servers may comprise any suitable type of server. As a result, a private office network comprising the integrated communication server may be modified as desired to provide any suitable service to subscribers by including a server operable to provide that service. Accordingly, the integrated communication server provides a private office network that is scalable based on the services which are to be provided to subscribers for that network.

Other technical advantages will be readily apparent to one skilled in the art from the following figures, description, and claims.

### BRIEF DESCRIPTION OF THE DRAWINGS

For a more complete understanding of the present invention and its advantages, reference is now made to the following description taken in conjunction with the accompanying drawings, wherein like reference numerals represent like parts, in which:

FIG. 1 is a block diagram illustrating a communication system in accordance with one embodiment of the present invention;

FIG. 2 is a block diagram illustrating details of the service engine of FIG. 1 in accordance with one embodiment of the present invention;

FIG. 3 is a block diagram illustrating details of the data processor of FIG. 2 in accordance with one embodiment of the present invention;

FIG. 4 is a block diagram illustrating details of the external data publisher of FIG. 2 in accordance with one embodiment of the present invention;

FIG. 5 is a flow diagram illustrating a method for providing the integrated communication server of FIG. 1 in accordance with one embodiment of the present invention;

FIG. 6 is a flow diagram illustrating a method for managing the mobile devices of FIG. 1 in accordance with one embodiment of the present invention;

FIG. 7 is a flow diagram illustrating a method for providing data applications for the mobile devices of FIG. 1 in accordance with one embodiment of the present invention; and

FIG. 8 is a flow diagram illustrating a method for providing data applications for the mobile devices of FIG. 1 in accordance with another embodiment of the present invention.

### DETAILED DESCRIPTION OF THE INVENTION

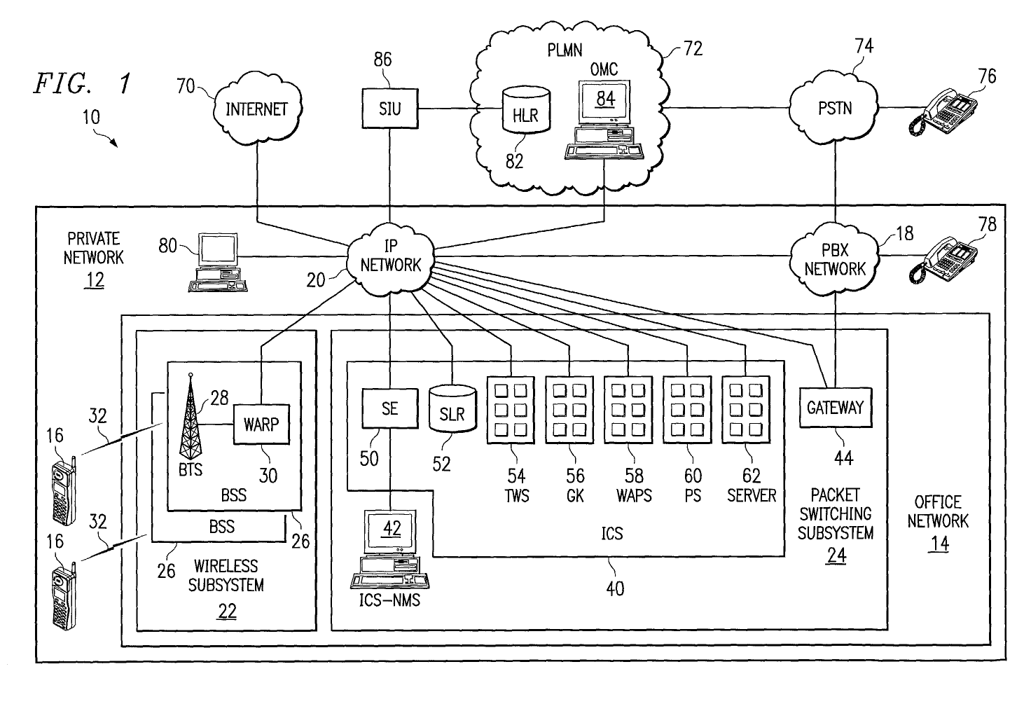

FIG. 1 is a block diagram illustrating a communication system 10 in accordance with one embodiment of the present invention. The system 10 comprises a private network 12 for providing communication for a plurality of authorized subscribers. According to one embodiment, the private network 12 comprises a communication network for a particular business enterprise and the authorized subscribers comprise business personnel. The private network 12 comprises an office network 14 for providing communication between a plurality of mobile devices 16, a private branch exchange (PBX) network 18, and an Internet Protocol (IP) network 20.

The office network 14 comprises a wireless subsystem 22 for communicating with the mobile devices 16 and a packet switching subsystem 24 for providing operations, administration, maintenance and provisioning (OAMP) functionality for the private network 12. The wireless subsystem 22 comprises one or more base station subsystems (BSS) 26. Each base system subsystem 26 comprises one or more base transceiver stations (BTS), or base stations, 28 and a corresponding wireless adjunct Internet platform (WARP) 30. Each base station 28 is operable to provide communication between the corresponding WARP 30 and mobile devices 16 located in a specified geographical area. As used herein, “each” means every one of at least a subset of the identified items.

Authorized mobile devices 16 are operable to provide wireless communication within the private network 12 for authorized subscribers. The mobile devices 16 may comprise cellular telephones or other suitable devices capable of providing wireless communication. According to one embodiment, the mobile devices 16 comprise Global System for Mobile communication (GSM) Phase 2 or higher mobile devices 16. Each mobile device 16 is operable to communicate with a base station 28 over a wireless interface 32. The wireless interface 32 may comprise any suitable wireless interface operable to transfer circuit-switched or packet-switched messages between a mobile device 16 and the base station 28. For example, the wireless interface 32 may comprise a GSM/GPRS (GSM/general packet radio service) interface, a GSM/EDGE (GSM/enhanced data rate for GSM evolution) interface, or other suitable interface.

The WARP 30 is operable to provide authorized mobile devices 16 with access to internal and/or external voice and/or data networks by providing voice and/or data messages received from the mobile devices 16 to the IP network 20 and messages received from the IP network 20 to the mobile devices 16. In accordance with one embodiment, the WARP 30 is operable to communicate with the mobile devices 16 through the base station 28 using a circuit-switched protocol and is operable to communicate with the IP network 20 using a packet-switched protocol. For this embodiment, the WARP 30 is operable to perform an interworking function to translate between the circuit-switched and packet-switched protocols. Thus, for example, the WARP 30 may packetize messages from the mobile devices 16 into data packets for transmission to the IP network 20 and may depacketize messages contained in data packets received from the IP network 20 for transmission to the mobile devices 16.

The packet switching subsystem 24 comprises an integrated communication server (ICS) 40, a network management station (NMS) 42, and a PBX gateway (GW) 44. The ICS 40 is operable to integrate a plurality of network elements such that an operator may perform OAMP functions for each of the network elements through the ICS 40. Thus, for example, an operator may perform OAMP functions for the packet switching subsystem 24 through a single interface for the ICS 40 displayed at the NMS 42.

The ICS 40 comprises a plurality of network elements. These network elements may comprise a service engine 50 for providing data services to subscribers and for providing an integrated OAMP interface for an operator, a subscriber location register (SLR) 52 for providing subscriber management functions for the office network 14, a teleworking server (TWS) 54 for providing PBX features through Hicom Feature Access interfacing and functionality, a gatekeeper 56 for coordinating call control functionality, a wireless application protocol server (WAPS) 58 for receiving and transmitting data for WAP subscribers, a push server (PS) 60 for providing server-initiated, or push, transaction functionality for the mobile devices 16, and/or any other suitable server 62.

Each of the network elements 50, 52, 54, 56, 58, 60 and 62 may comprise logic encoded in media. The logic comprises functional instructions for carrying out program tasks. The media comprises computer disks or other computer-readable media, application-specific integrated circuits (ASICs), field-programmable gate arrays (FPGAs), digital signal processors (DSPs), other suitable specific or general purpose processors, transmission media or other suitable media in which logic may be encoded and utilized. As described in more detail below, the ICS 40 may comprise one or more of the servers 54, 58, 60 and 62 based on the types of services to be provided by the office network 14 to subscribers as selected by an operator through the NMS 42.

The gateway 44 is operable to transfer messages between the PBX network 18 and the IP network 20. According to one embodiment, the gateway 44 is operable to communicate with the PBX network 18 using a circuit-switched protocol and with the IP network 20 using a packet-switched protocol. For this embodiment, the gateway 44 is operable to perform an interworking function to translate between the circuit-switched and packet-switched protocols. Thus, for example, the gateway 44 may packetize messages into data packets for transmission to the IP network 20 and may depacketize messages contained in data packets received from the IP network 20.

The communication system 10 may also comprise the Internet 70, a public land mobile network (PLMN) 72, and a public switched telephone network (PSTN) 74. The PLMN 72 is operable to provide communication for mobile devices 16, and the PSTN 74 is operable to provide communication for telephony devices 76, such as standard telephones, clients and computers using modems or digital subscriber line connections. The IP network 20 may be coupled to the Internet 70 and to the PLMN 72 to provide communication between the private network 12 and both the Internet 70 and the PLMN 72. The PSTN 74 may be coupled to the PLMN 72 and to the PBX network 18. Thus, the private network 12 may communicate with the PSTN 74 through the PBX network 18 and/or through the IP network 20 via the PLMN 72.

The PBX network 18 is operable to process circuit-switched messages for the private network 12. The PBX network 18 is coupled to the IP network 20, the packet switching subsystem 24, the PSTN 74, and one or more PBX telephones 78. The PBX network 18 may comprise any suitable network operable to transmit and receive circuit-switched messages. In accordance with one embodiment, the gateway 44 and the gatekeeper 56 may perform the functions of a PBX network 18. For this embodiment, the private network 12 may not comprise a separate PBX network 18.

The IP network 20 is operable to transmit and receive data packets to and from network addresses in the IP network 20. The IP network 20 may comprise a local area network, a wide area network, or any other suitable packet-switched network. In addition to the PBX network 18, the Internet 70 and the PLMN 72, the IP network 20 is coupled to the wireless subsystem 22 and to the packet switching subsystem 24.

The IP network 20 may also be coupled to an external data source 80, either directly or through any other suitable network such as the Internet 70. The external data source 80 is operable to transmit and receive data to and from the IP network 20. The external data source 80 may comprise one or more workstations or other suitable devices that are operable to execute one or more external data applications, such as MICROSOFT EXCHANGE, LOTUS NOTES, or any other suitable external data application. The external data source 80 may also comprise one or more databases, such as a corporate database for the business enterprise, that are operable to store external data in any suitable format. The external data source 80 is external in that the data communicated between the IP network 20 and the external data source 80 is in a format other than an internal format that is processable by the ICS 40.

The PLMN 72 comprises a home location register (HLR) 82 and an operations and maintenance center (OMC) 84. The HLR 82 is operable to coordinate location management, authentication, service management, subscriber management, and any other suitable functions for the PLMN 72. The HLR 82 is also operable to coordinate location management for mobile devices 16 roaming between the private network 12 and the PLMN 72. The OMC 84 is operable to provide management functions for the WARPs 30. The HLR 82 may be coupled to the IP network 20 through an SS7-IP interworking unit (SIU) 86. The SIU 86 interfaces with the WARPs 30 through the IP network 20 and with the PLMN 72 via a mobility-signaling link.

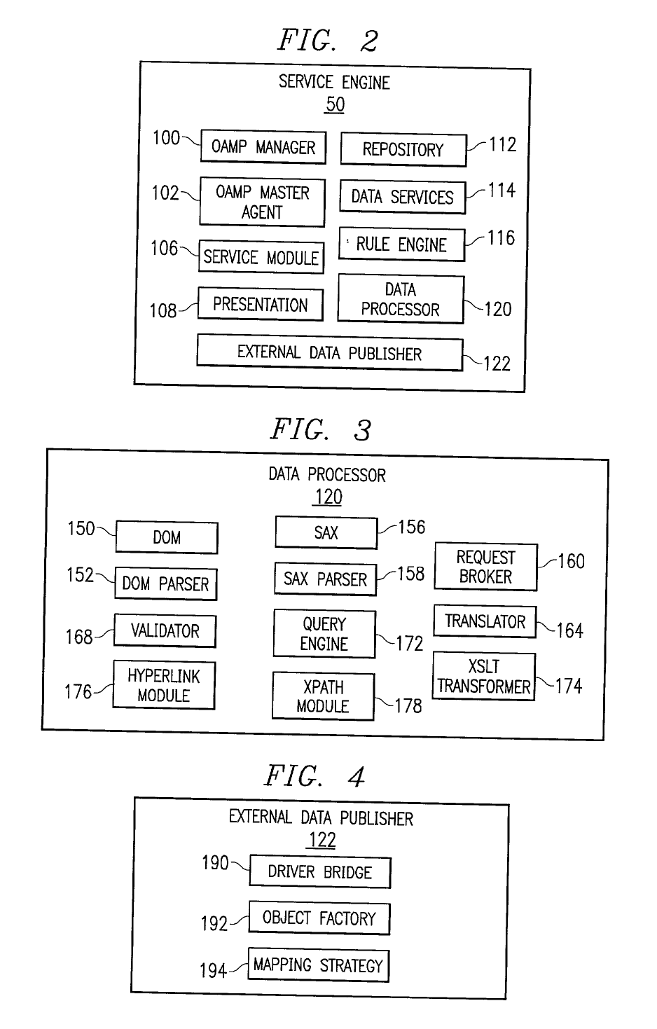

FIG. 2 is a block diagram illustrating details of the service engine 50 in accordance with one embodiment of the present invention. The service engine 50 is operable to provide an integrated OAMP interface for an operator through the NMS 42 and to provide data services to subscribers. As described in more detail below, the service engine 50 allows an operator to configure the ICS 40 based on the particular services to be provided to subscribers through the office network 14.

The service engine 50 comprises an OAMP manager 100 for providing simple network management protocol (SNMP) functions, an OAMP master agent 102 for managing subagents, a service module 106 for routing data through the service engine 50, a presentation module 108 for displaying information to users, a repository 112 for storing data, data services 114 for managing the repository 112, a rule engine 116 for determining which network elements to include in the ICS 40, a data processor 120 for processing internal and external data for the ICS 40, and an external data publisher 122 for converting data between an internal format and any suitable external format.

The manager 100, the master agent 102, the service module 106, the presentation module 108, the repository 112, the data services 114, the rule engine 116, the data processor 120 and the external data publisher 122 may each comprise logic encoded in media. The logic comprises functional instructions for carrying out program tasks. The media comprises computer disks or other computer-readable media, ASICs, FPGAs, DSPs, other suitable specific or general purpose processors, transmission media or other suitable media in which logic may be encoded and utilized. The repository 112 may also comprise any suitable data store or combination of data stores operable to provide persistent data storage for the service engine 50.

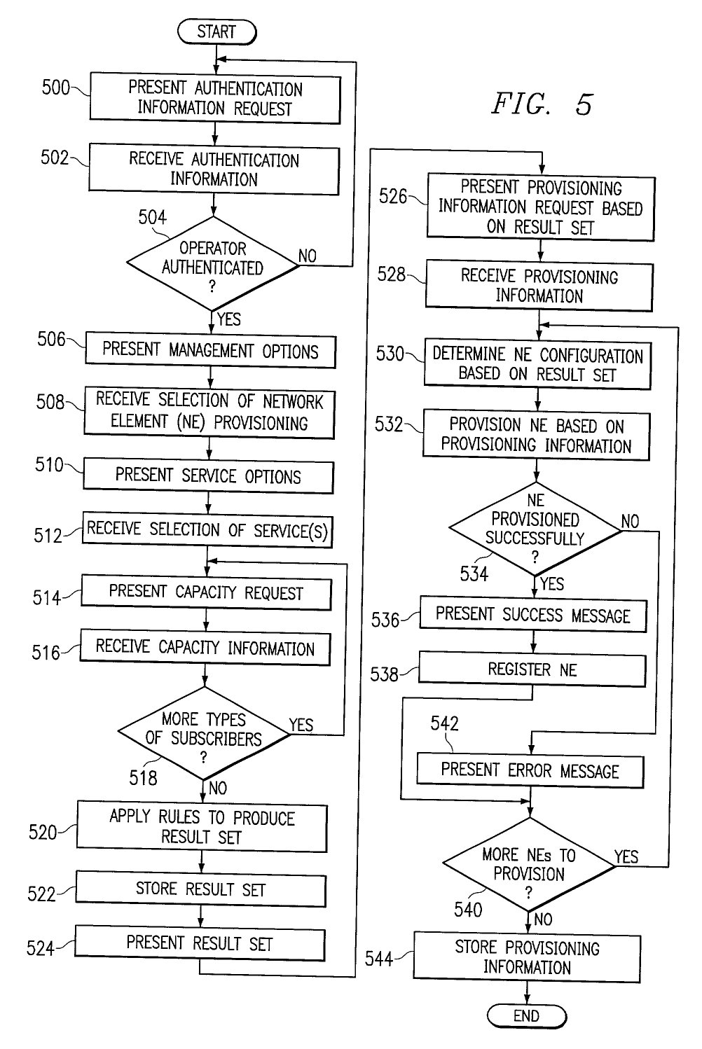

The manager 100 is operable to provide SNMP functions for the ICS 40 and for any SNMP V2 compliant network management station. The manager 100 is also operable to allow the service module 106 to obtain and modify management data, to receive notification when specified events occur for particular subagents, to generate commands to send to subagents, and to receive responses to the commands from the subagents. The subagents comprise any servers 54, 58, 60 and/or 62 which exist in the ICS 40 based on the types of services to be provided by the office network 14 to subscribers, as described in more detail below in connection with FIG. 5. Thus, for example, the manager 100 is operable to form conditions to provision subagents and to obtain alarms from the subagents.

The master agent 102 is operable to maintain a list of registered subagents for the ICS 40. As each server 54, 58, 60 and/or 62 is included in the ICS 40 during network element provisioning, the server 54, 58, 60 or 62 registers as a subagent with the master agent 102 of the service engine 50. Thus, if a registered server 54, 58, 60 or 62 fails and thus appears to be missing to the service engine 50, the service engine 50 will recognize and respond to the failure. However, the service engine 50 will not recognize a missing server 54, 58, 60 or 62 as a failure if the server 54, 58, 60 or 62 was not included in the ICS 40 during network element provisioning and registered as a subagent with the master agent 102.

The service module 106 is operable to route data to and from the service engine 50 and to coordinate data transformations during routing. As such, the service module 106 is operable to handle network configuration requests, to deliver text messages to WAP-enabled devices, to deliver text notifications regarding meetings, e-mail and the like to mobile devices 16, and to manage subscriber configuration requests and WAP requests. The service module 106 is also operable to maintain a list of registered interfaces and their supporting components, as well as information about which component supports which services for the office network 14. The components may dynamically register their interfaces with the service module 106 so that a component may be interchanged or replaced without affecting the supported interface.

The presentation module 108 is operable to provide a web-based user interface to the ICS 40. As such, the presentation module 108 is operable to provide an interface for user operations and user validation, as well as validation of basic data entry. The presentation module 108 is also operable to send user operation requests to the service module 106 for routing and further processing and to display the returned results to the user. The user operations may comprise subscriber provisioning, network element provisioning, subscriber profile configuration, and any other suitable user operation. Validation performed by the presentation module 108 may comprise type checking, field length validation, format validation, range checking, business rule checking, and any other suitable data validation.

The repository 112 is operable to provide transaction management, connection pooling, and thread management for the ICS 40. The repository 112 may comprise a plurality of drivers for communicating with data sources internal or external to the ICS 40. For example, the repository 112 may comprise JDBC-ODBC drivers, Native API drivers, JDBC-Net Pure Java drivers, Native-Protocol Pure Java drivers, and any other suitable drivers.

The data services 114 are operable to translate higher-level data requests into basic data operations. As such, the data services 114 are operable to receive requests for data stored in the repository 112 and to locate and retrieve the data from the repository 112. The data services 114 are also operable to receive data for storage in the repository 112 and to store the data in the appropriate location in the repository 112. For example, if the repository 112 comprises a plurality of databases, the data services 114 are operable to store the data in the appropriate database of the repository 112.

The rule engine 116 is operable to receive service and capacity information and other relevant information from an operator through the NMS 42 and to determine which network elements, such as servers 54, 58, 60 and/or 62, to include in the ICS 40 based on the service and capacity information, as described in more detail below in connection with FIG. 5. According to one embodiment, the rule engine 116 applies a specified set of rules, which may be stored in the rule engine 116 and/or the repository 112 and which may be modified at any suitable time, to the service and capacity information in order to produce a result set. Based on the result set, the rule engine 116 is operable to determine which network elements to include in the ICS 40. The result set may be stored in the repository 112 such that the result set is available at a later time. Thus, for example, if the office network 14 fails, the result set may be retrieved from the repository 112 in order to re-configure the ICS 40 without requiring the operator to provide the service and capacity information again.

FIG. 3 is a block diagram illustrating details of the data processor 120 in accordance with one embodiment of the present invention. The data processor 120 is operable to provide a plurality of utilities for processing data within the ICS 40. The data processor 120 may comprise a plurality of components, including a document object model (DOM) 150, a DOM parser 152, a SAX 156, a SAX parser 158, a request broker 160, a translator 164, a validator 168, a query engine 172, an XSLT transformer 174, a hyperlink module 176, an Xpath module 178 and any other suitable component.

Each of the components 150, 152, 156, 158, 160, 164, 168, 172, 174, 176 and 178 may comprise logic encoded in media. The logic comprises functional instructions for carrying out program tasks. The media comprises computer disks or other computer-readable media, ASICs, FPGAs, DSPs, other suitable specific or general purpose processors, transmission media or other suitable media in which logic may be encoded and utilized.

The DOM 150 is operable to implement a Document Object Model Level 1 or other suitable platform- and language-neutral interface that allows programs and scripts to dynamically access and update the content, structure and style of documents. According to one embodiment, the DOM 150 is operable to provide a standard set of objects for representing hypertext markup language (HTML) and extensible markup language (XML) documents, a standard model of how these objects may be combined, and a standard interface for accessing and manipulating these objects. The DOM parser 152 is operable to provide services related to XML parsing using DOM methodology.

The SAX 156 is operable to provide a standard interface for event-based XML parsing. Using SAX 156, a relatively simple, low-level access to an XML document may be provided. This allows parsing of documents that are larger than available system memory and allows the construction of data structures through the use of callback event handlers. The SAX parser 158 is operable to provide services related to XML parsing using SAX methodology.

The request broker 160 is operable to include any suitable new service or technology related to XML data processing without affecting currently available services. The translator 164 is operable to provide any suitable services related to XML translation. The validator 168 is operable to provide any suitable validation services. For example, the validator 168 may validate XML data against DTD. The query engine 172 is operable to provide any suitable services related to identifying actual XML data for a user.

The XSLT transformer 174 is operable to implement the specification of XSLT language. As such, the XSLT transformer 174 is operable to describe rules for transforming a source tree into a result tree. The XSLT transformer 174 is also operable to perform transformations by associating patterns with templates. A pattern is matched against elements in the source tree, and a template is instantiated to create part of the result tree. In constructing the result tree, elements from the source tree may be filtered and re-ordered such that the result tree may comprise a structure different from the structure of the source tree.

The hyperlink module 176 is operable to implement linking and addressing through an XML linking language (Xlink) and an XML pointer language (Xpointer). The Xlink allows elements to be inserted into XML documents to create and describe links between resources. Using XML syntax, Xlink may create structures that describe unidirectional hyperlinks for HTML. The Xpointer supports addressing into the internal structures of XML documents. The Xpointer may provide for specific reference to elements, character strings, and any other suitable structure of an XML document. The Xpath module 178 is operable to implement the specification of an Xpath. The Xpath is operable to provide a common syntax and semantics for functionality that is shared between XSL transformations and the Xpointer.

FIG. 4 is a block diagram illustrating details of the external data publisher 122 in accordance with one embodiment of the present invention. The external data publisher 122 is operable to convert data received from an external data source 80 in an external format into data in an internal format that is processable by the ICS 40. According to one embodiment, the external data publisher 122 may convert data from external data sources 80 such as RDBMS, LOTUS NOTES, MICROSOFT EXCHANGE, LDAP, OODBMS, and any other suitable external data source. The external data publisher 122 may convert the external data into an internal format such as XML or other suitable format.

The external data publisher 122 comprises a driver bridge 190, an object factory 192 and a mapping strategy 194. The driver bridge 190, the object factory 192 and the mapping strategy 194 may each comprise logic encoded in media. The logic comprises functional instructions for carrying out program tasks. The media comprises computer disks or other computer-readable media, ASICs, FPGAs, DSPs, other suitable specific or general purpose processors, transmission media or other suitable media in which logic may be encoded and utilized.

The driver bridge 190 is operable to implement an abstraction of the external data formats from which may be data may be converted into the internal data format. As a result, an interface for each external data source 80 is decoupled from its implementation such that the external data source 80 can vary independently from the implementation. This allows the implementation to be selected or switched at runtime. According to one embodiment, the abstractions and the implementations are extensible by subclassing. In addition, the implementation of an abstraction by the driver bridge 190 has no impact on the object factory 192.

The object factory 192 is operable to receive external data in an external format from an external data source 80 and convert the data into internal data in an internal format that is processable by the ICS 40. Similarly, the object factory 192 is operable to convert internal data in the internal format into external data in an external format for an external data source 80.

The mapping strategy 194 is operable to provide a plurality of algorithms by which the object factory 192 may convert external data from external formats into internal data in an internal format. According to one embodiment, the algorithms may be encapsulated in order to make them interchangeable. Thus, each algorithm may vary independently from the clients using the algorithm.

FIG. 5 is a flow diagram illustrating a method for providing the integrated communication server 40 in accordance with one embodiment of the present invention. The method begins at step 500 where the ICS 40 presents a request for authentication information to an operator through the NMS 42. At step 502, the ICS 40 receives authentication information from the operator. The authentication information may comprise a user identifier, a password, and the like.

At decisional step 504, if the operator is not authenticated based on the authentication information, the method follows the No branch from decisional step 504 and returns to step 500 where the request for authentication information is presented again. However, if the operator is authenticated based on the authentication information, the method follows the Yes branch from decisional step 504 to step 506.

At step 504, the ICS 40 presents management options to the operator. These options may comprise, for example, network element provisioning, configuration management, state management, fault management, software management, performance management, and/or any other suitable management option. At step 508, the ICS 40 receives a selection of network element provisioning from the operator. At step 510, the ICS 40 presents service options to the operator. At step 512, the ICS 40 receives a selection of one or more services from the operator.

At step 512, the ICS 40 presents a capacity request to the operator. At step 516, the ICS 40 receives capacity information from the operator regarding the capacity for a particular type of subscriber. At decisional step 518, a determination is made regarding whether or not there are more types of subscribers based on information provided by the operator. If there are more types of subscribers, the method follows the Yes branch from decisional step 518 and returns to step 514 where the ICS 40 presents a capacity request for another type of subscriber. However, if there are no more types of subscribers, the method follows the No branch from decisional step 518 to step 520.

At step 520, the rule engine 116 applies rules stored in the repository 112 in order to produce a result set based on the services selected by the operator and the capacity information for each type of subscriber. According to one embodiment, the result set identifies which network elements, such as servers 54, 58, 60 and/or 62, are to be included in the ICS 40. At step 522, the result set is stored in the repository 112. At step 524, the ICS 40 presents the result set to the operator through the NMS 42.

At step 526, the ICS 40 presents a request for provisioning information based on the result set. At step 528, the ICS 40 receives provisioning information from the operator in accordance with the network elements identified for inclusion in the ICS 40. At step 530, the ICS 40 determines configuration parameters for a network element for the ICS 40 based on the result set. For example, the ICS 40 may locate a particular version of the network element at a remote location and download the network element from the remote location to the packet switching subsystem 24 of the office network 14. At step 532, the ICS 40 provisions the retrieved network element based on the provisioning information received from the operator. At this point, the ICS 40 may also install and activate the network element.

At decisional step 534, a determination is made regarding whether or not the network element was provisioned successfully. If the network element was provisioned successfully, the method follows the Yes branch from decisional step 534 to step 536. At step 536, the ICS 40 presents a Success message to the operator. At step 538, the network element is registered as a subagent with the master agent 102. According to one embodiment, the network element registers itself with the master agent 102 by sending a registration message to the master agent 102. The method then continues to decisional step 540.

Returning the decisional step 534, if the network element was not provisioned successfully, the method follows the No branch from decisional step 534 to step 542. At step 542, the ICS 40 presents an Error message to the operator. The method then continues to decisional step 540.

At decisional step 540, a determination is made regarding whether or not there are more network elements to provision. If there are more network elements to provision, the method follows the Yes branch from decisional step 540 and returns to step 530 where another network element is retrieved. However, if there are no more network elements to provision, the method follows the No branch from decisional step 540 to step 544. At step 544, the provisioning information for the registered network elements is stored in the repository 112, at which point the method comes to an end.

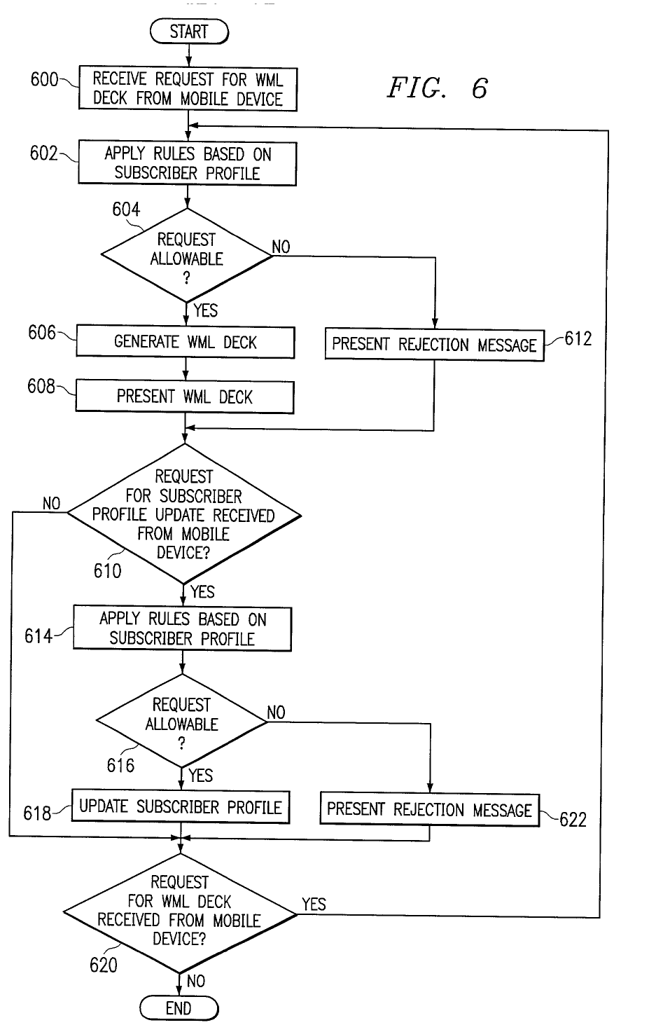

FIG. 6 is a flow diagram illustrating a method for managing the mobile devices 16 in accordance with one embodiment of the present invention. The method begins at step 600 where the ICS 40 receives a request for a wireless markup language (WML) deck from a mobile device 16. At step 602, based on the subscriber profile in the SLR 52, the ICS 40 applies rules to determine the allowability of the request.

At decisional step 604, the ICS 40 determines whether or not the request is allowable. If the request is allowable, the method follows the Yes branch from decisional step 604 to step 606. At step 606, the ICS 40 generates the WML deck for the mobile device 16. At step 608, the ICS 40 presents the WML deck to the mobile device 16. The method then continues to decisional step 610.

Returning to decisional step 604, if the request was not allowable, the method follows the No branch from decisional step 604 to step 612. At step 612, the ICS 40 presents a Rejection message to the mobile device 16. The method then continues to decisional step 610.

At decisional step 610, the ICS 40 determines whether or not a request for a subscriber profile update has been received from the mobile device 16. If a subscriber profile update request has been received from a mobile device 16, the method follows the Yes branch from decisional step 610 to step 614. At step 614, based on the subscriber profile in the SLR 52 for the mobile device 16, the ICS 40 applies rules to determine whether or not the request is allowable.

At decisional step 616, the ICS 40 determines whether or not the request is allowable. If the request is allowable, the method follows the Yes branch from decisional step 616 to step 618. At step 618, the subscriber profile in the SLR 52 for the mobile device 16 is updated. The method then continues to decisional step 620.

Returning to decisional step 616, if the request is not allowable, the method follows the No branch from decisional step 616 to step 622. At step 622, the ICS 40 presents a Rejection message to the mobile device 16. The method then continues to decisional step 620.

Returning to decisional step 610, if a request for a subscriber profile update has not been received from the mobile device 16 after a specified period of time, the method follows the No branch from decisional step 610 to decisional step 620.

At decisional step 620, the ICS 40 determines whether or not a request for a new WML deck has been received from the mobile device 16. If a request for a new WML deck has been received from the mobile device 16, the method follows the Yes branch from decisional step 620 and returns to step 602 where the ICS 40 applies rules based on the subscriber profile in the SLR 52 to determine whether or not the request is allowable. However, if no request is received for a new WML deck from the mobile device 16 after a specified period of time, the method follows the No branch from decisional step 620 and comes to an end.

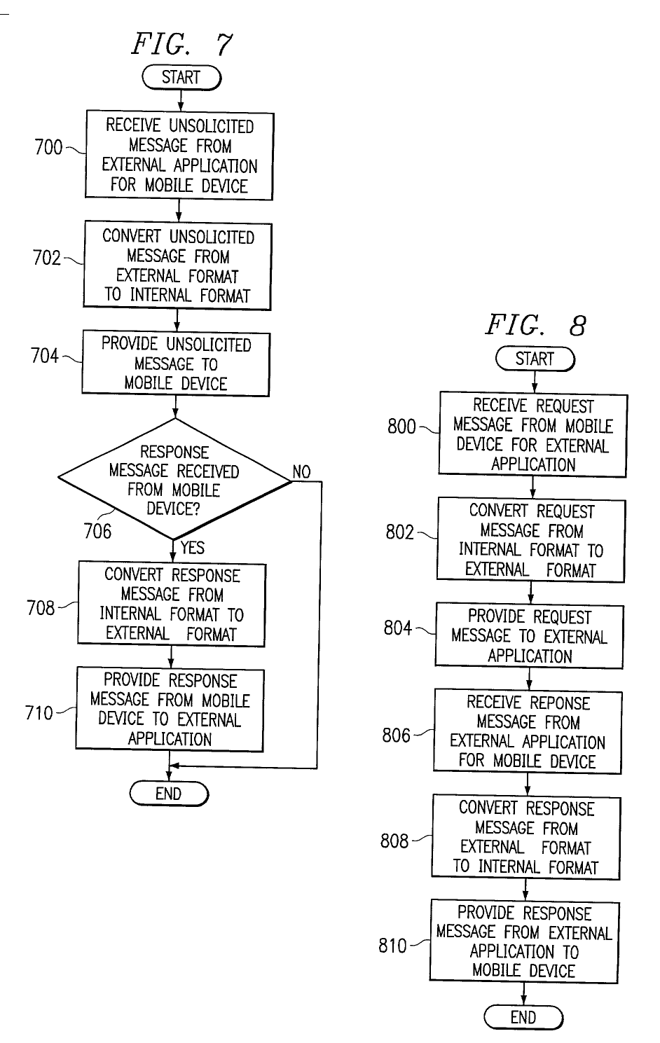

FIG. 7 is a flow diagram illustrating a method for providing data applications for the mobile devices 16 in accordance with one embodiment of the present invention. The method begins at step 700 where the ICS 40 receives an unsolicited message for a mobile device 16 from an external application executed on an external data source 80. At step 702, the external data publisher 122 converts the unsolicited message from the external format corresponding to the external application to an internal format that is processable by the ICS 40. At step 704, the ICS 40 provides the unsolicited message to the mobile device 16.

At decisional step 706, the ICS 40 makes a determination regarding whether a response message has been received from the mobile device 16. If no response message has been received from the mobile device 16, the method follows the No branch from decisional step 706 and comes to an end. However, if a response message has been received from the mobile device 16, the method follows the Yes branch from decisional step 706 to step 708.

At step 708, the external data publisher 122 converts the response message from the internal format to the external format corresponding to the external application. At step 710, the ICS 40 provides the response message from the mobile device 16 to the external application at the external data source 80, at which point the method comes to an end.

FIG. 8 is a flow diagram illustrating a method for providing data applications for the mobile devices 16 in accordance with another embodiment of the present invention. The method begins at step 800 where the ICS 40 receives a request message from a mobile device 16 for an external application being executed on an external data source 80.

At step 802, the external data publisher 122 converts the request message from an internal format that is processable by the ICS 40 into an external format corresponding to the external application on the external data source 80. At step 804, the ICS 40 provides the request message to the external data source 80 for the external application.

At step 806, the ICS 40 receives a response message from the external application for the mobile device 16. At step 808, the external data publisher 122 converts the response message from the external format to the internal format. At step 810, the ICS 40 provides the response message to the mobile device 16, at which point the method comes to an end.

Although the present invention has been described with several embodiments, various changes and modifications may be suggested to one skilled in the art. It is intended that the present invention encompass such changes and modifications as fall within the scope of the appended claims.

What is claimed is:

1. A method for providing an integrated communication server, comprising:
receiving a selection of at least one service option;
receiving capacity information for at least one type of subscriber;
applying a specified set of rules to produce a result set based on the service option selection and the capacity information; and
determining configuration parameters for one or more network elements based on the result set.

2. The method of claim 1, further comprising:
receiving provisioning information based on the result set; and
provisioning each of the network elements based on the provisioning information.

3. The method of claim 2, further comprising registering each of the network elements when the network element is provisioned successfully.

4. The method of claim 2, further comprising storing the provisioning information.

5. The method of claim 1, further comprising storing the result set.

6. The method of claim 1, determining configuration parameters comprising locating the network elements at a location remote from the integrated communication server and downloading the network elements from the remote location.

7. The method of claim 1, further comprising:
receiving authentication information from an operator;
determining whether the operator is authenticated based on the authentication information;
presenting management options when the operator is authenticated, the management options comprising network element provisioning; and
receiving a selection of network element provisioning.

8. A system for providing an integrated communication server, comprising:
a computer-processable medium; and
logic stored on the computer-processable medium, the logic operable to receive a selection of at least one service option, to receive capacity information for at least one type of subscriber, to apply a specified set of rules to produce a result set based on the service option selection and the capacity information, and to determine configuration parameters for one or more network elements based on the result set.

9. The system of claim 8, the logic further operable to receive provisioning information based on the result set and to provision each of the network elements based on the provisioning information.

10. The system of claim 9, the logic further operable to register each of the network elements when the network element is provisioned successfully.

11. The system of claim 9, the logic further operable to store the provisioning information.

12. The system of claim 8, the logic further operable to store the result set.

13. The system of claim 8, the logic further operable to determine configuration parameters by locating the network elements at a location remote from the integrated communication server and downloading the network elements from the remote location.

14. The system of claim 8, the logic further operable to receive authentication information from an operator, to determine whether the operator is authenticated based on the authentication information, to present management options when the operator is authenticated, the management options comprising network element provisioning, and to receive a selection of network element provisioning.

15. A service engine for providing an integrated communication server (ICS), comprising a rule engine operable to receive service and capacity information, to determine which of a plurality of network elements to include in the ICS based on the service and capacity information, and to determine configuration parameters for one or more network elements based on the result set.

16. The service engine of claim 15, further comprising a manager operable to receive provisioning information based on the result set and to provision each of the network elements based on the provisioning information.

17. The service engine of claim 16, further comprising:
a repository operable to provide persistent data storage for the service engine; and
data services operable to receive requests for data stored in the repository and to locate and retrieve the data from the repository and operable to receive data for storage in the service engine and to store the data in the repository.

18. The service engine of claim 17, the repository further operable to store the provisioning information and the result set.

19. The service engine of claim 16, further comprising a master agent operable to maintain a list of registered network elements for the ICS, each of the network elements operable to be registered with the master agent when the network element is provisioned successfully.

20. The service engine of claim 15, the rule engine operable to determine configuration parameters by locating the network elements at a location remote from the ICS and downloading the network elements from the remote location.

21. A method for providing an integrated communication server, comprising:
receiving authentication information from an operator;
determining whether the operator is authenticated based on the authentication information;
presenting management options when the operator is authenticated, the management options comprising network element provisioning;
receiving a selection of network element provisioning;
receiving a selection of at least one service option;
receiving capacity information for at least one type of subscriber;
applying a specified set of rules to produce a result set based on the service option selection and the capacity information;
determining configuration parameters for one or more network elements based on the result set by locating the network elements at a location remote from the integrated communication server and downloading the network elements from the remote location;
receiving provisioning information based on the result set;
provisioning each of the network elements based on the provisioning information;
registering each of the network elements when the network element is provisioned successfully; and
storing the provisioning information and the result set.
